(19) United States
(12) Patent Application Publication
(10) Pub. No.: US 2013/0265275 A1
(43) Pub. Date: Oct. 10, 2013

(54) ELECTRONIC DEVICE AND TOUCH DEVICE HAVING THREE-DIMENSIONAL VIRTUAL CONTROL

(71) Applicants: Jui-Tsung Liao, New Taipei City (TW); Ding-Teng Hou, New Taipei City (TW)

(72) Inventors: Jui-Tsung Liao, New Taipei City (TW); Ding-Teng Hou, New Taipei City (TW)

(21) Appl. No.: 13/558,811

(22) Filed: Jul. 26, 2012

(30) Foreign Application Priority Data
Apr. 6, 2012 (TW) 101112405

(51) Int. Cl. G06F 3/044; G06F 3/041

(52) U.S. Cl. 345/174; 345/173

(57) ABSTRACT

A touch device having 3D virtual control has a touch module, a backlight, a 3D light grating film, a pattern layer and a control module. The 3D light grating film and the pattern layer are respectively connected to top surfaces of the touch module and the backlight. The pattern layer has at least one pattern of keypad. The touch module and the backlight are electronically connected to the control module. Not only can the touch device use the touch module to provide the function of a touch pad, but also the control module allows users to operate or pick patterns through the pattern layer having 3D effect to perform functions or commands corresponding to the patterns.

### BACKGROUND OF THE INVENTION

1. Field of the Invention

The present invention relates to a touch device and more particularly to a touch device having three-dimensional (3D) virtual control.

2. Description of the Related Art

Touch pads have been extensively applied to notebook computers to provide input function similar to that of computer mice among all available technologies. To users accustomed to notebook computers, it is understandable that to compromise for size reduction, many hot keys of notebook computers are removed or combination keys are employed to replace some keys on standard keyboards. If those discarded hot keys should be used for input, external keypads must be connected to the notebook computers such that the hot keys can still be provided by the physical keypads.

The tablet personal computers (PC) have recently boomed to challenge or even replace the roles of notebook computers in many aspects. However, the input means of the tablet PCs is performed by handwriting on touch panels. As far as the users are accustomed to notebook computers, the handwriting speed is far slower than the keyboard input. Once the users have large input demand, the tablet PCs still must rely on external keypads to increase input efficiency. Generally, the so-called external keypads pertain to reduced standard keyboards. For sake of the specifications of the standard keyboards, users are limited to the input functions provided by the keys of the standard keyboards.

As the current computer market is full of various types of computers, different types of computers are equipped with dedicated input devices to facilitate users' input. However, when users demand for an integrated input means, current input devices are not effective to deliver effective and satisfactory solutions.

### SUMMARY OF THE INVENTION

A first objective of the present invention is to provide a touch device having 3D virtual control for users to selectively switch between a touch pad and a hot keypad, thereby providing different input options to computer users.

To achieve the foregoing objective, the touch device has a touch module, a backlight, a 3D light grating film, a pattern layer and a control module.

The backlight is stacked on the touch module.

The 3D light grating film is connected to an outer side of the touch module.

The pattern layer is connected to an inner side of the 3D light grating film and has at least one pattern thereon.

The control module is electronically connected to the touch module and the backlight.

The touch device can provide both a touch pad and virtual keys for input. When the touch device is inputted through the touch pad, the control module serves as a controller of the touch module to identify the coordinates of touched positions on the touch module. When the touch device is inputted through the virtual keys, the backlight and touch module are simultaneously driven and 3D virtual keys are visible as the patterns of keys on the pattern layer are illuminated by light generated by the backlight through the 3D light grating film. When a pattern of a 3D virtual key is pressed, the control module identifies the coordinates of a touch position corresponding to the pattern and sends out a command to perform a corresponding function. Accordingly, users can select either one of the touch pad and virtual keys on the touch device for input, depending on their own demands.

A second objective of the present invention is to provide an electronic device having the foregoing touch device. The touch device is mounted on the electronic device having an input function. The electronic device has a physical or virtual switch connected to the control module of the touch device for users to switch input between the touch pad and the virtual keys.

The electronic device includes, but not limited to, a computer keyboard and a notebook computer.

Other objectives, advantages and novel features of the invention will become more apparent from the following detailed description when taken in conjunction with the accompanying drawings.

### BRIEF DESCRIPTION OF THE DRAWINGS

FIG. 1 is a schematic side view in partial section of an embodiment of a touch device having 3D virtual control in accordance with the present invention;

FIG. 2 is a top view of a pattern layer of the touch device in FIG. 1;

FIG. 3 is a schematic top view of a touch module of the touch device in FIG. 1;

FIG. 4 is a perspective view of a keyboard having the touch device in FIG. 1 therein;

FIG. 5 is a perspective view of the keyboard in FIG. 4 showing virtual keys thereon;

FIG. 6 is a perspective view of a notebook computer having the touch device in FIG. 1 therein; and

FIG. 7 is a schematic side view in partial section of another embodiment of a touch device having 3D virtual control in accordance with the present invention.

### DETAILED DESCRIPTION OF THE INVENTION

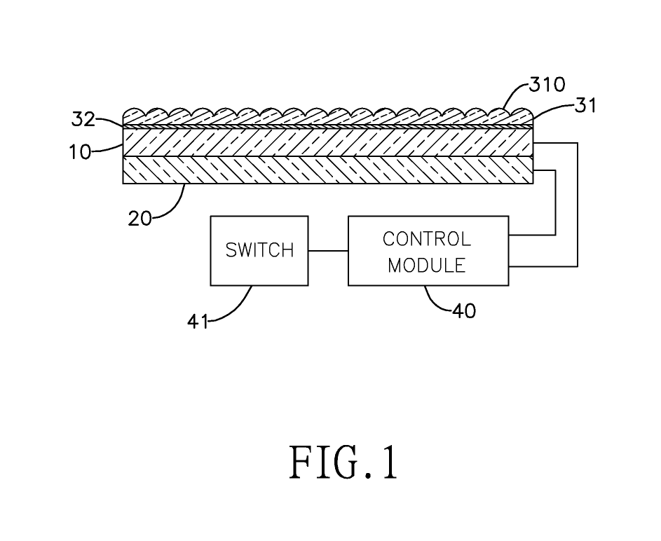

With reference to FIG. 1, a first embodiment of a touch device having 3D virtual control in accordance with the present invention has a backlight 20, a touch module 10, a pattern layer 32, a 3D light grating film 31 and a control module 40. The 3D light grating film 31, the pattern layer 32, the touch module 10 and the backlight 20 are sequentially stacked. The touch module 10 and the backlight 20 are electronically connected to the control module 40.

In the present embodiment, the touch module 10 is connected to an outer side of the backlight 20.

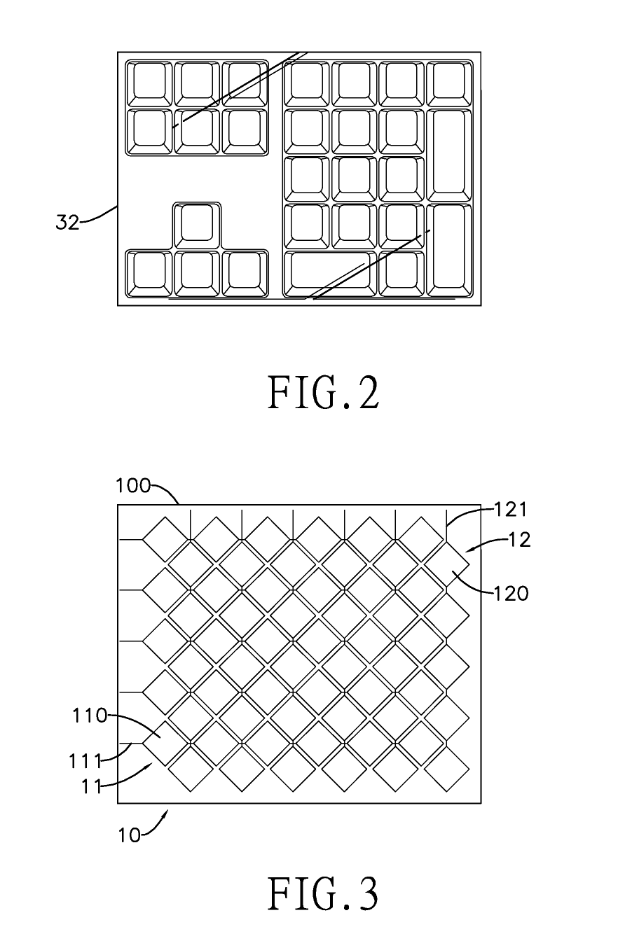

The pattern layer 32 is printed on an outer side (top surface) of the touch module 10 by using a fluorescent paint layer and has a pattern, such as a 3D pattern generated by a 3D visual grating generation software according to a specification of the 3D light grating film 31, for example, the number of the circular bumps 310, serving to generate a 3D pattern or generating a pattern in collaboration with the 3D light grating film 31. The pattern is designed based on additionally equipped functions, and may be selected from one of a keypad, a multimedia control panel, a calculator, a graphics tablet and the like. The pattern layer 32 may have a pattern containing at least one keypad. With reference to FIG. 2, the pattern layer 32 has a pattern containing two keypads. The two keypads are similar to the numeric keypad and the hot keypad of a standard keyboard. The numeric keypad is composed of multiple patterns of numeric keys. The hot keypad is composed of multiple patterns of hot keys.

The 3D light grating film 31 is mounted on the pattern layer 32 and is generally referred to as a layer capable of generating a 3D visual effect, such as multiple circular bumps 310 having identical diameter and connected to each other for generating a 3D visual effect on the pattern layer 32 underneath the 3D light grating film 31.

With reference to FIG. 3, the touch module 10 is composed of a capacitive touch panel, relates more particularly to a projected capacitive touch panel, and has a transparent substrate 100, an X-axis sensing layer 11 and a Y-axis sensing layer 12. The X-axis sensing layer 11 and the Y-axis sensing layer 12 are formed on one side or respectively formed on two sides of the transparent substrate 100. The X-axis sensing layer 11 is composed of multiple rows of X-axis sensing electrodes 110 arranged transversely and in parallel. Each row of X-axis sensing electrodes 110 has multiple X-axis sensing electrodes 110 connected in series. The Y-axis sensing layer 12 is composed of multiple columns of Y-axis sensing electrodes 120 arranged longitudinally and in parallel and perpendicularly intersecting with the rows of X-axis sensing electrodes 110. Each row of Y-axis sensing electrodes 120 has multiple Y-axis sensing electrodes 120 connected in series. The X-axis sensing electrodes 110 and the Y-axis sensing electrodes 120 are alternately arranged on the transparent substrate 100. A coupling capacitor is formed between each X-axis sensing electrode 110 and one of the Y-axis sensing electrodes 120 adjacent to the X-axis electrode 110. When the touch panel is touched, the characteristic that the capacitance value at the touched position will vary is used to determine the coordinates of the touched position. Each row of X-axis sensing electrodes 110 is connected to an X-axis sensing line 111. Each column of Y-axis sensing electrodes 120 is connected to a Y-axis sensing line 121. Each X-axis sensing line 111 and each Y-axis sensing line 121 are connected to the control module 40.

The X-axis sensing layer 11 and the Y-axis sensing layer 12 are composed of indium tin oxide (ITO). Hence, the touch module 10 is transparent. If the touch module is not fully transparent, certain degree of transmittance should be allowed for the patterns on the pattern layer 32 to be recognized.

The control module 40 has an input terminal for switching command, which is connected with electronic device and serves to receive a switching command.

When the touch device is externally connected to an electronic device, the touch device may further have a switch, including, but not limited to, a mechanical switch, an electronic switch, a touch switch and the like. The switch 41 is connected to the input terminal for switching command and is operated to determine if a switching command is sent out. When the touch device is directly embedded in an electronic device, the electronic device may have the switch mounted thereon or use application software to generate a switching command for controlling the touch device to switch its operation mode. What worth paying attention to is that firmware inside the electronic device or an input device must be also switched when the input mode of the touch device is switched to the virtual key input. However, firmware switching pertains to conventional switching technique and is therefore not discussed here.

As mentioned in the foregoing description, the touch device of the present invention can be inputted through both a touch pad and virtual keys. When the touch device is switched to an input mode through a touch pad, the touch module 10 is collaborated with the control module 40 to perform touch functions. Specifically, the control module 40 identifies a preset function, such as identifying users' touch event, and tracking monitoring event, cursor control event and the like on the touch module 10. When the touch device is switched to an input mode through virtual keys, the control module 40 first drives the backlight 20 to emit light and the pattern layer 32 on the inner side of the backlight 20 is visible. A 3D visual effect is generated when the pattern layer 32 is viewed through the 3D light grating film 31 on the outer side of the backlight 20. In other words, users can see 3D patterns, such as a virtual keypad, shown on the touch device. When users touch any key in the virtual keypad, the control module 40 lets the touch device 10 identify the coordinates of touched positions and perform preset functions or commands corresponding to the displayed patterns having the coordinates, such as hot keys, numeric keypad, multimedia operation control, calculator, graphics tablet and the like, to provide additional functions.

To ensure the sense of real key press when the virtual keys are pressed, the touch device further has a touch response module. The touch response module is connected to the control module 40 and contacts the touch module 10. The touch response module serves to generate vibration in response to a touch event. In other words, after detecting a touch event on the touch module 10, the control module 40 not only identifies the coordinates touched in the touch event but also drives the touch response module to generate vibration in response to the touch event.

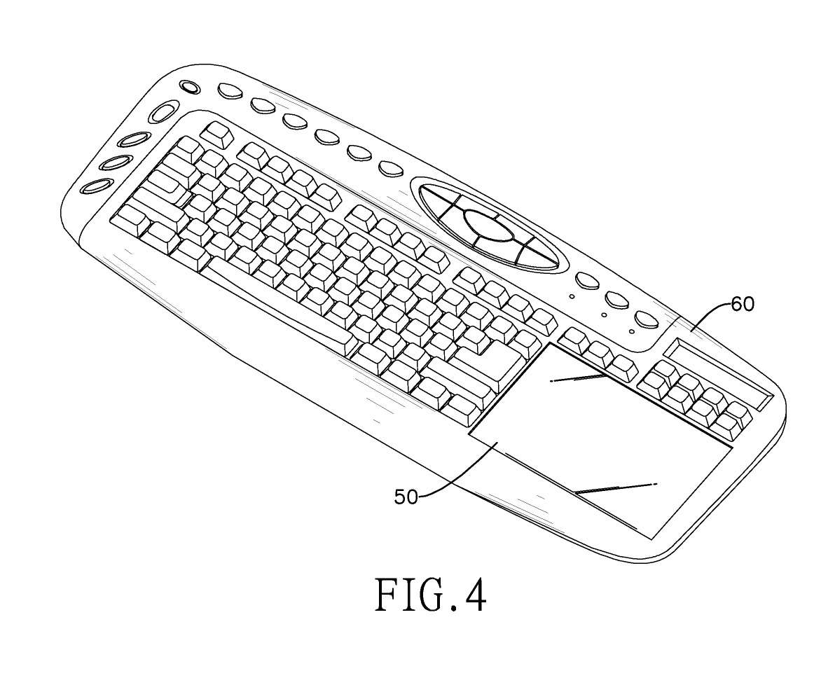

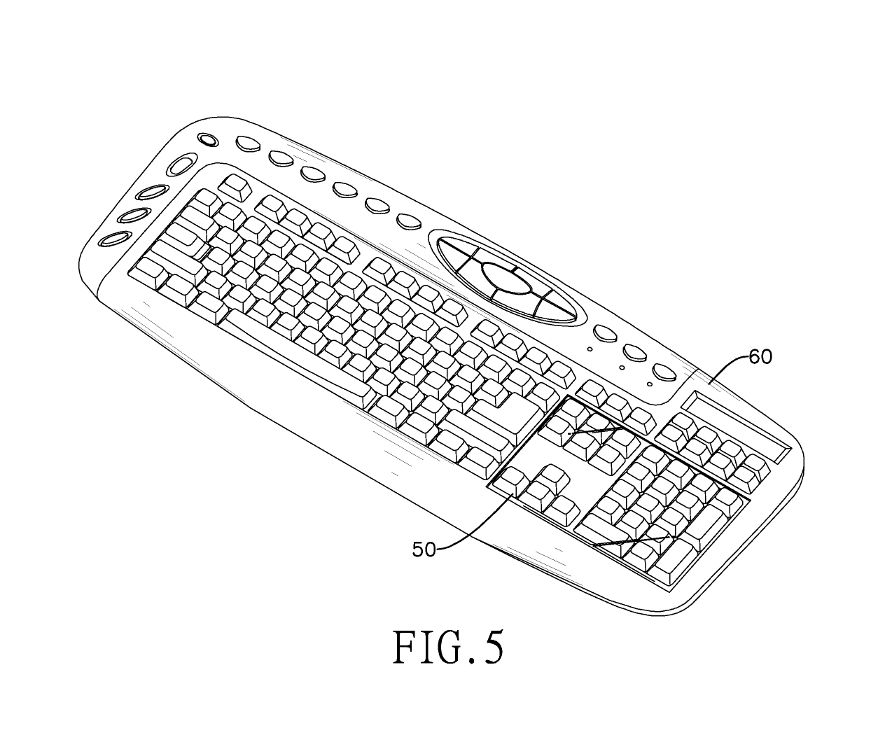

The touch device may be a standalone peripheral device or integrated into an electronic device, which is an input device itself or has an input function requirement. The electronic device has a body. The body may be a keyboard or any type of electronic information device, such as a casing of a notebook computer. With reference to FIG. 4, the touch device 50 is applied to a keyboard 60. The touch device 50 is mounted on a right side of the keyboard 60. When displaying no 3D patterns, the touch device 50 serves as a touch pad so that users can touch the touch device 50 to perform a touch function or other control functions. With reference to FIG. 5, when the touch device 50 is switched to the input mode through virtual keys, the backlight is lit, the virtual key and multiple virtual keys (virtual keypad) composed of a 3D pattern are visible from an external part of the touch device, and input functions corresponding to the touched virtual keys are performed.

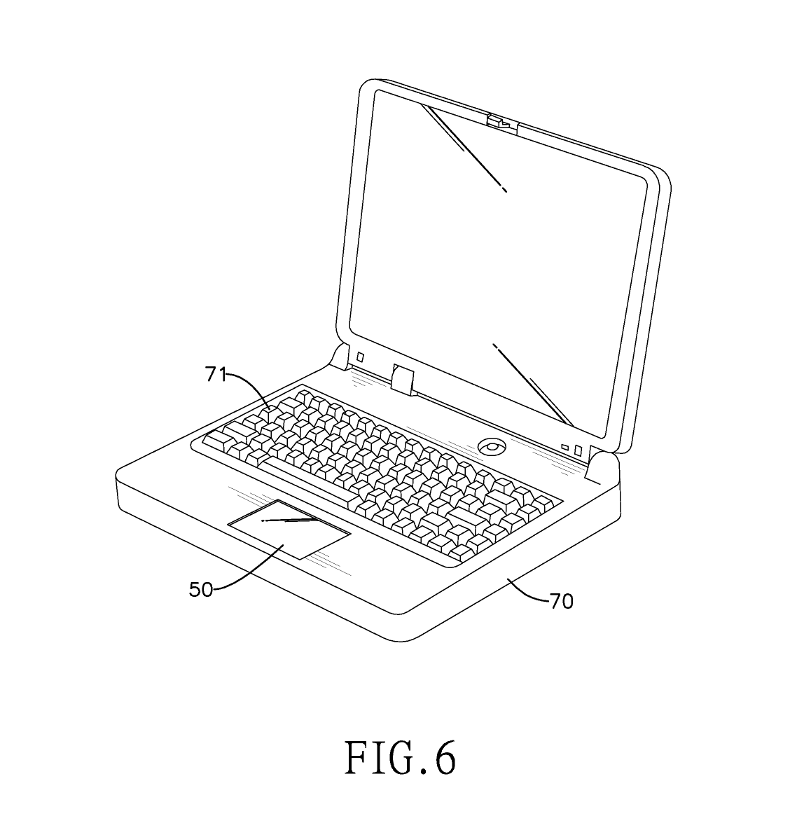

As mentioned, the touch device 50 may be also mounted on an electronic device having an input function requirement. The electronic device may be a notebook computer or any electronic information device. With reference to FIG. 6, the touch device 50 is mounted between a front edge and a keyboard 71 of a notebook computer 70 to replace an original touch pad. In other words, given the touch device 50, the notebook computer 70 has not only the input functions through the original touch pad but also the keypad input functions or other preset control functions through the touch device 50, such as operation of a jog wheel or a shuttle dial.

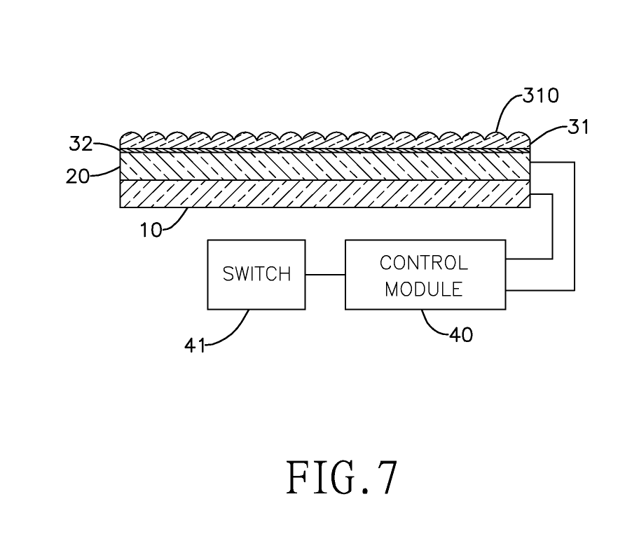

With reference to FIG. 7, another embodiment of a touch device having 3D virtual control in accordance with the present invention has a backlight 20, a touch module 10, a pattern layer 32, a 3D light grating film 31 and a control module 40. The 3D light grating film 31, the pattern layer 32, the backlight 20 and the touch module 10 are sequentially stacked. The touch module 10 and the backlight 20 are electronically connected to the control module 40.

In the present embodiment, the backlight 20 is connected to an outer side of the touch module 10. The pattern layer 32 is printed on an outer side (top surface) of the touch module 10 by using a fluorescent paint layer. The 3D light grating film 31 covers the pattern layer 32. As being on the inner side of the backlight 20, the touch module 10 is not necessary to be transparent.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A touch device having three-dimensional (3D) virtual control, comprising:
a touch module;
a backlight stacked on the touch module;
a 3D light grating film connected to an outer side of the touch module;
a pattern layer connected to an inner side of the 3D light grating film and having at least one pattern thereon; and
a control module electronically connected to the touch module and the backlight.

2. The touch device as claimed in claim 1, wherein the backlight is connected to an inner side of the touch module, and the pattern layer is formed on the outer side of the touch module and is located on the inner side of the 3D light grating film.

3. The touch device as claimed in claim 1, wherein the touch module is connected to an inner side of the backlight, and the pattern layer is formed on an outer side of the backlight and is located on the inner side of the 3D light grating film.

4. The touch device as claimed in claim 1, wherein the control module is connected to a touch response module and contacts the touch module.

5. The touch device as claimed in claim 4, wherein the touch module is composed of a capacitive touch panel.

6. The touch device as claimed in claim 5, wherein the touch module is composed of a projected capacitive touch panel.

7. The touch device as claimed in claim 4, wherein the pattern layer is composed of a printed fluorescent paint layer.

8. The touch device as claimed in claim 4, wherein the control module has an input terminal for switching command.

9. An electronic device comprising a touch device having 3D virtual control, the touch device comprising:
a touch module;
a backlight stacked on the touch module;
a 3D light grating film connected to an outer side of the touch module;
a pattern layer connected to an inner side of the 3D light grating film and having at least one pattern thereon; and
a control module electronically connected to the touch module and the backlight and electrically connected to the electronic device.

10. The electronic device as claimed in claim 9, wherein the electronic device is one of an information device and an input device.

11. The electronic device as claimed in claim 9, further comprising:
a body; and
a switch mounted on the body and connected to the control module of the touch device.

12. The electronic device as claimed in claim 9, wherein the electronic device generates a switching command to switch an operation mode of the control module.
